(19) United States
(12) Patent Application Publication
(10) Pub. No.: US 2009/0136020 A1
(43) Pub. Date: May 28, 2009

(54) METHOD AND APPARATUS FOR ECHO CANCELLATION

(76) Inventors: Weifeng Wang, Shanghai (CN); Caogang Yu, Shanghai (CN)

Correspondence Address: PERKINS COIE LLP;PATENT-SEA, P.O. BOX 1247, SEATTLE, WA, 98111-1247, US

(21) Appl. No.: 12/272,282

(22) Filed: Nov. 17, 2008

(30) Foreign Application Priority Data
Nov. 22, 2007 (CN) 200710094322.7

(51) Int. Cl. H04M 9/08

(52) U.S. Cl. 379/406.08; 379/406.01

(57) ABSTRACT

A method and apparatus for echo cancellation is disclosed. The apparatus includes an echo compensator and a double talk detector. The echo compensator compensates for associated feedback echo by filtering an echo component from a receiver input signal. The double talk detector provides a control signal based on comparisons of a receiver output signal to a threshold signal and to a transmit signal. The echo compensator also selectively updates filter parameters based on the control signal.

### CROSS-REFERENCE TO RELATED APPLICATION

This application claims priority to Chinese Patent Application No. 200710094322.7, filed Nov. 28, 2007, the disclosure of which is hereby incorporated by reference in its entirety.

### TECHNICAL FIELD

The present disclosure is related to methods and apparatus for echo cancellation, for example, to compensate for echo created in communications system hybrids.

### BACKGROUND

Hybrids are employed in some telecommunications systems to interface two-wire (e.g., bidirectional pairs) and four-wire (e.g., separate transmit and receive pairs) telecommunications circuits. For example, hybrids may be employed to interface local-loop circuits to long distance circuits or to interface local-loop circuits to customer premise equipment. Parasitic effects, impedance mismatches, and other non-idealities may cause a signal transmitted via the transmit pair into the four-wire interface to echo onto the receive pair of the four-wire interface. Such echo may cause increased noise, increased interference, an increased bit-error-rate, and/or the like.

Compensating for, canceling, or otherwise decreasing the detrimental effects of echo may be complicated when the echo is relatively strong. Decreasing the detrimental effects of echo may also be complicated by double talk. Double talk may occur if audio is transmitted via the transmit pair while audio is received via the receive pair.

### BRIEF DESCRIPTION OF THE DRAWINGS

FIG. 1 is a block diagram of an echo canceller in accordance with an embodiment of the invention;

FIG. 2 is a block diagram of an echo compensator usable in the echo canceller of FIG. 1 in accordance with an embodiment of the invention;

FIG. 3 is a block diagram of a double talk detector usable in the echo canceller of FIG. 1 in accordance with an embodiment of the invention;

FIG. 4 is a block diagram of an echo canceller in accordance with another embodiment of the invention;

FIG. 5 is a block diagram of a double talk detector usable in the echo canceller of FIG. 1 in accordance with an embodiment of the invention; and

FIG. 6 is a flowchart of a process that may be implemented by the digital logic module of FIG. 5.

### DETAILED DESCRIPTION

The following disclosure describes several embodiments of the invention. Several details describing well-known structures or processes are not set forth in the following description for purposes of brevity and clarity. Also, several other embodiments of the invention can have different configurations, components, or procedures than those described in this Detailed Description. A person of ordinary skill in the art, therefore, will accordingly understand that the invention may have other embodiments with additional elements, or the invention may have other embodiments without several of the elements shown and described below with reference to the figures. The term “based on” is not exclusive and is equivalent to the term “based, at least in part, on” and includes being based on additional factors, whether or not the additional factors are described herein.

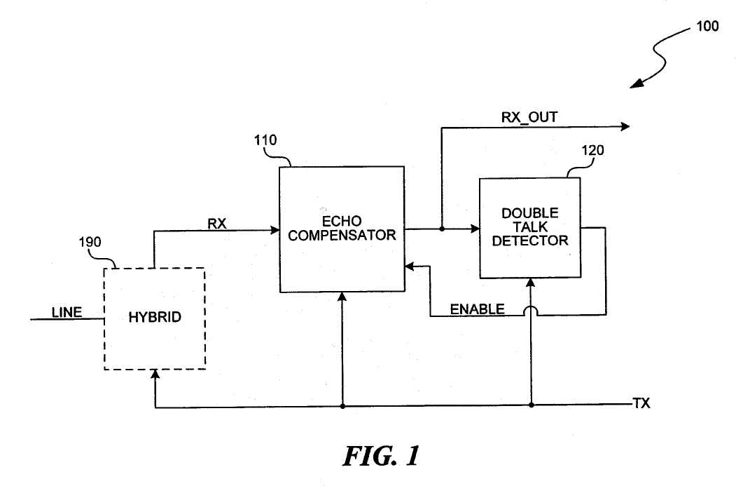

FIG. 1 is a block diagram of echo canceller 100. As illustrated, echo canceller 100 includes echo compensator 110 and double talk detector 120. In one embodiment, echo canceller 100 is configured to receive transmit signal TX, to receive receiver input signal RX, and to provide receiver output signal RX_OUT. Echo canceller 100 may also be configured to interface with hybrid 190. An application-specific integrated circuit (ASIC), discrete components, a mixed signal integrated circuit, and/or the like may be employed in echo canceller 100. Echo canceller 100 may also include analog circuitry, digital circuitry, or mixed analog/digital circuitry, be implemented as digital signal processor (DSP) code, and/or the like.

Echo canceller 100 may be employed in a wide variety of applications such as wireless phones, conventional telephones, and/or systems where echo cancellation may be beneficial. For example, systems for which echo cancellation may be beneficial include headsets, hearing aids, modems, facsimile machines, and/or the like. Further, echo canceller 100 may be employed in a communications network to compensate for the echo created through hybrid 190. In one example, echo canceller 100 is employed in and/or in conjunction with a digital subscriber line (DSL) system.

In one embodiment, receiver input signal RX may be a voice or data signal received via hybrid 190 and may include an echo component and a received signal component. The frequency ranges of the echo component and the received signal component may also partially and/or wholly overlap. However, in other embodiments, the frequency ranges of the echo component and the received signal component may be separate.

The echo component may include echo from transmit signal TX and may be due to, for example, the feedback of transmit signal TX to receiver input signal RX through hybrid 190; non-idealities such as component variance, impedance mismatch, and circuit parasitic effects in hybrid 190; and/or the like. Likewise, transmit signal TX may be a voice or data signal to be transmitted via hybrid 190. Receiver input signal RX and transmit signal TX may be digital voice signals, analog voice signals, digital data signals, analog data signals, and/or the like.

As shown, echo compensator 110 is configured to receive transmit signal TX, to receive control signal ENABLE, to receive receiver input signal RX, and to provide receiver output signal RX_OUT. Echo compensator 110 may be configured to provide receiver output signal RX_OUT based on filtering the echo component from receiver input signal RX. For example, echo compensator 110 may be configured such that receiver output signal RX_OUT is substantially equal to the received signal component of receiver input signal RX. Echo compensator 110 may be configured to employ adaptive filtration and iterative approximation techniques as described below.

Double talk detector 120 is configured to receive receiver output signal RX_OUT, to receive transmit signal TX, and to provide control signal ENABLE. In one embodiment, double talk detector 120 is configured to detect double talk. For example, double talk detector 120 may function to selectively enable the adjustment and/or adaptation of echo compensator 110 such that echo compensator 110 is primarily adjusted and/or adapted in response to changes in the echo component of receiver input signal RX while control signal ENABLE is asserted and is held substantially unchanged while control signal ENABLE is deasserted. Any suitable logic levels may be employed. Likewise, signals may be provided as either active-high or active-low signals. In this way, echo canceller 100 may be selectively adapted to provide improved echo cancellation.

Hybrid 190 may be configured to interface a bidirectional signal to a receive signal and a transmit signal. For example, hybrid 190 may include a transformer configured to interface four-wire telephone customer premises equipment to a two-wire local-loop circuit. However, hybrid 190 may also include any other bidirectional to unidirectional interfaces.

Although not shown in FIG. 1, receiver output signal RX_OUT may be received by other components; further signal processing such as amplification, error correction, or modulation/demodulation may be performed; and/or the like.

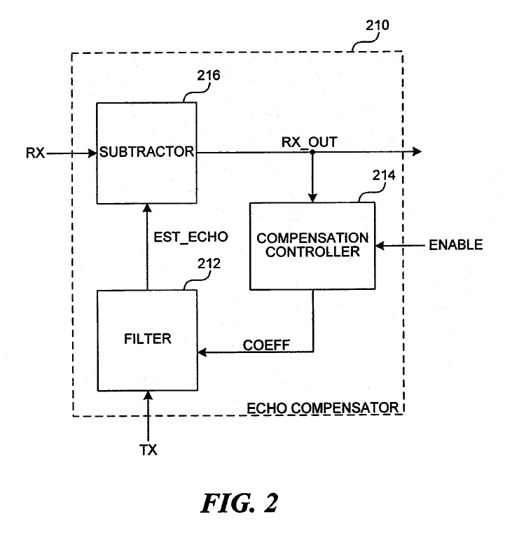

FIG. 2 is a block diagram of echo compensator 210. As illustrated, echo compensator 210 includes filter 212, compensation controller 214, and subtractor 216. Echo compensator 210 may be employed as an embodiment of echo compensator 110.

As shown, filter 212 is configured to receive signal COEFF, to receive transmit signal TX, and to provide estimated echo signal EST_ECHO. Filter 212 may be configured to provide estimated echo signal EST_ECHO as an estimate of the echo component of receiver input signal RX from transmit signal TX and may include a digital filter such as a finite impulse response (FIR) filter. However, infinite impulse response (IIR) filters, analog filters, and/or the like may also be suitably employed as filter 212.

Compensation controller 214 is configured to receive control signal ENABLE, to receive receiver output signal RX_OUT, and to provide signal COEFF. Compensation controller 214 may be configured to estimate the echo component of receiver input signal RX and provide signal COEFF based on this estimate. For example, compensation controller 214 may be configured to dynamically generate and/or adjust coefficients provided on signal COEFF, such as FIR or IIR filter coefficients.

Subtractor 216 is configured to receive estimated echo signal EST_ECHO, to receive receiver input signal RX, and to provide receiver output signal RX_OUT. Subtractor 216 may provide receiver output signal RX_OUT based on subtracting estimated echo signal EST_ECHO from receiver input signal RX. In one embodiment, subtractor 216 includes a digital subtractor. However, subtractor 216 may also include an analog subtractor, be implemented as DSP code, and/or the like.

In operation, filter 212, compensation controller 214, and subtractor 216 operate in cooperation with each other to filter the echo component of receiver input signal RX to provide receiver output signal RX_OUT. For example, filtering the echo component may include attenuating amplitude, power, and/or the like of the echo component while leaving the received signal component substantially unchanged.

In one embodiment, echo compensator 210 may employ a least mean squares algorithm (LMS) or normalized least mean squares (NLMS) algorithm to approximate the echo component of receiver input signal RX and to subtract the approximated echo component from receiver input signal RX to provide receiver output signal RX_OUT. A suitable NLMS algorithm may characterized by the following equation:

$${a}_{k} ( n + 1 ) = {a}_{k} ( n ) + \frac{μ e ( n )}{P ( n )} * y ( n ) ,$$

where n represents an iteration number, aₖ(n) represents filter coefficients (e.g., the coefficients provided on signal COEFF), μ represents an iteration step size, e(n) represents receiver output signal RX_OUT, P(n) represents the power of receiver input signal RX, and y(n) represents receiver input signal RX. In operation, the value of step size μ may be empirically determined.

The above characterized NLMS algorithm may be employed by compensation controller 214 to generate signal COEFF based on the residual echo on receiver output signal RX_OUT. Signal COEFF may then be employed by filter 212 to generate estimated echo signal EST_ECHO. For example, filter 212 may be a FIR filter implemented in DSP code to dynamically adjust performance metrics such as pole/zero frequencies, passband gain, stopband attenuation, bandwidth, and/or the like in response to signal COEFF.

In one embodiment, filter 212 and compensation controller 214 may be configured to also provide a gain of approximately 6 decibels such that echo with an amplitude that is less than or equal to approximately twice the amplitude of transmit signal TX may be cancelled. However, any suitable gain may be selected.

As discussed above, filter 212 is configured to provide estimated echo signal EST_ECHO to subtractor 216 based on coefficients from compensation controller 214. Subtractor 216 may be configured to then subtract estimated echo signal EST_ECHO from receiver input signal RX to provide receiver output signal RX_OUT. Successive iterations may be performed to additionally reduce the echo on receiver output signal RX_OUT. For example, successive iterations may be performed while the error, e(n), is greater than the iteration step value, μ, until control signal ENABLE is deasserted to indicate the presence of double talk, and/or the like.

As discussed above, echo compensator 210 may be implemented as DSP code. In such an embodiment, estimated echo signal EST_ECHO and receiver input signal RX may be represented by a vector of bit length M and subtractor 216 may truncate one or more least significant bits (LSB), leaving one or more most significant bits (MSB). Such bit length modification may be employed to reduce DC error, which may result from fixed point calculations.

The bit length modification may be, for example, performed on complementary binary codes. For example, bit length modification may be performed by truncating bit positions less significant than N−1, where N describes a bit location of a vector, if the sign bit (e.g., the MSB), indicates that the vector represents a positive number. However, if the sign bit indicates that the vector represents a negative number, all LSBs less significant than N may be truncated.

As one example, source vector X may be modified to resulting vector Y, where X is of length M, and includes bits X[M−1] to X[0] such that:

Y=X[M−1:N−1], if X[M−1]=0; and

Y=X[M−1:N], if X[M−1]=1.

Similar techniques may also be employed by filter 212, compensation controller 214, double talk detector 120, and/or the like.

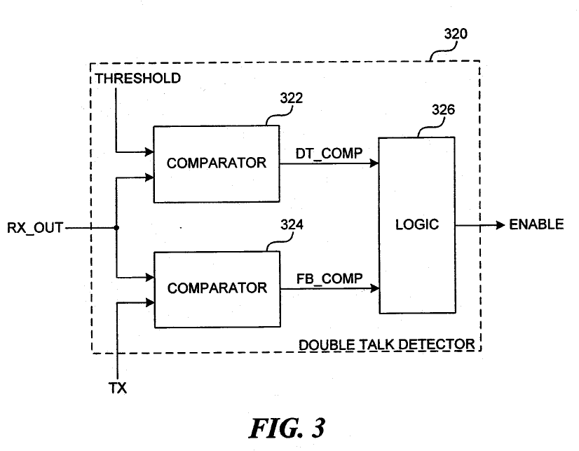

FIG. 3 is a block diagram of double talk detector 320, which may be employed as an embodiment of double talk detector 120. As shown, double talk detector includes comparator 322, comparator 324, and logic module 326. Double talk detector 320 may be configured to receive receiver output signal RX_OUT, to receive transmit signal TX, and to provide control signal ENABLE.

As illustrated, comparator 322 is configured to receive receiver output signal RX_OUT, to receive double talk threshold signal THRESHOLD, and to provide double talk comparison signal DT_COMP. Signal THRESHOLD may be an internally or externally programmed signal that may be provided from an internal or external memory, DSP, microprocessor, microcontroller, potentiometer, current source, and/or the like.

In one embodiment, comparator 322 may include a digital comparator configured to provide an arithmetic comparison of receiver output signal RX_OUT and signal THRESHOLD such that if a binary value of receiver output signal RX_OUT is greater than that of signal THRESHOLD, the presence of double talk is indicated via signal DT_COMP. However, if signals RX_OUT and THRESHOLD are analog signals, comparator 322 may include a voltage comparator, a current comparator, and/or the like.

Similarly, comparator 324 may be configured to receive receiver output signal RX_OUT, to receive transmit signal TX, and to provide feedback comparison signal FB_COMP. In one embodiment, comparator 324 may include a digital comparator configured to provide an arithmetic comparison of the receiver output signal RX_OUT and transmit signal TX such that if the binary value of the echo component of receiver output signal RX_OUT is greater than transmit signal TX, signal FB_COMP is asserted. However, if signals RX_OUT and TX are analog signals, comparator 322 may include a voltage comparator, a current comparator, and/or the like.

As shown, logic module 326 is configured to receive double talk comparison signal DT_COMP, to receive feedback comparison signal FB_COMP, and to provide control signal ENABLE. In one embodiment, logic module 326 includes an AND gate configured to logically AND signal DT_COMP to signal FB_COMP. For example, such an embodiment may provide a greater range of echo cancellation. However, in other embodiments, logic module 326 may include an OR gate configured to logically OR signal DT_COMP to signal FB_COMP, other combinatorial logic, state machines, and/or the like.

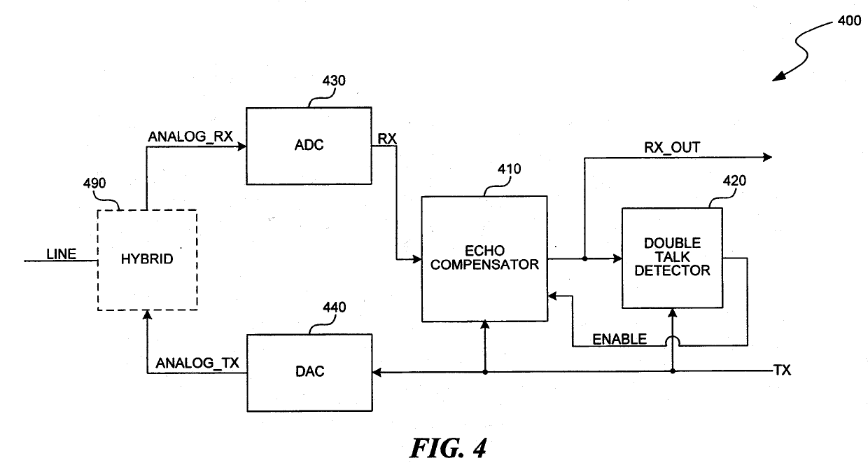

FIG. 4 is a block diagram of echo canceller 400. As illustrated, echo canceller 400 includes echo compensator 410, double talk detector 420, analog to digital converter (ADC) 430, and digital to analog converter (DAC) 440. Echo canceller 400 may be employed as an embodiment of echo canceller 100 of FIG. 1. As Illustrated in FIG. 4, transmit signal TX is a digital transmit signal and receiver input signal RX is a digital receiver input signal.

As shown, ADC 430 is configured to receive analog receiver input signal ANALOG_RX and to provide digital receiver input signal RX. In one embodiment, ADC 430 is a high linearity and high resolution ADC. However, any suitable ADC may also be employed.

As shown, DAC 440 is configured to receive digital transmit signal TX and to provide analog transmit signal TX. In one embodiment, DAC 440 is a high linearity and high resolution DAC. However, any suitable DAC may also be employed.

Echo compensator 410 and double talk detector 420 may also be respective embodiments of echo compensator 110 and double talk detector 120 of FIG. 1. Hybrid 490 may include a hybrid such as hybrid 190 of FIG. 1.

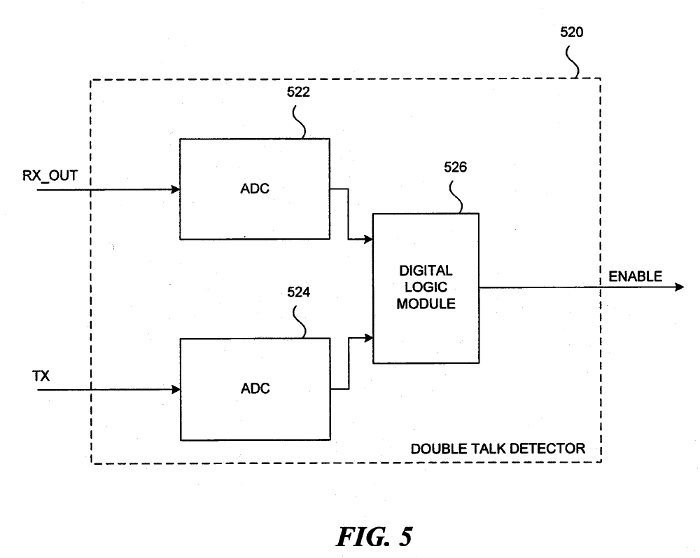

FIG. 5 is a block diagram of double talk detector 520. As shown in FIG. 5, double talk detector 520 includes analog-to-digital converter (ADC) 522, ADC 524, and digital logic module 526. Double talk detector 520 may be employed as an embodiment of double talk detector 120 of FIG. 1.

ADC 522 may be configured to receive analog receiver output signal RX_OUT and produce digital receiver output signal RX_OUT_N. ADC 524 may be configured to receive analog transmit signal TX and produce digital transmit signal TX_N. Many types of ADCs are suitable for use as ADCs 522 and 524, including successive-approximation ADCs, ramp-compare ADCs, delta-encoded ADCs, pipeline ADCs, Sigma-Delta ADCs, and/or the like.

As shown in FIG. 5, signals RX_OUT and TX are analog signals. However, in some embodiments, one or both of these signals may be digital signals and one or both of the ADC 522 or ADC 524 may be omitted. In such embodiments, digital logic module 526 may be configured to directly receive one or both of signals RX_OUT and/or TX.

Digital logic module 526 may configured to control echo compensator 110 via control signal ENABLE. For example, it may be configured to analyze signals RX_OUT_N and TX_N to determine whether a double-talk condition is present. Depending on the result of this determination, digital logic module 526 may modify the operational mode of echo compensator 110 by modulating control signal ENABLE. In some embodiments, digital logic module 526 may be implemented as DSP code to be executed on a DSP.

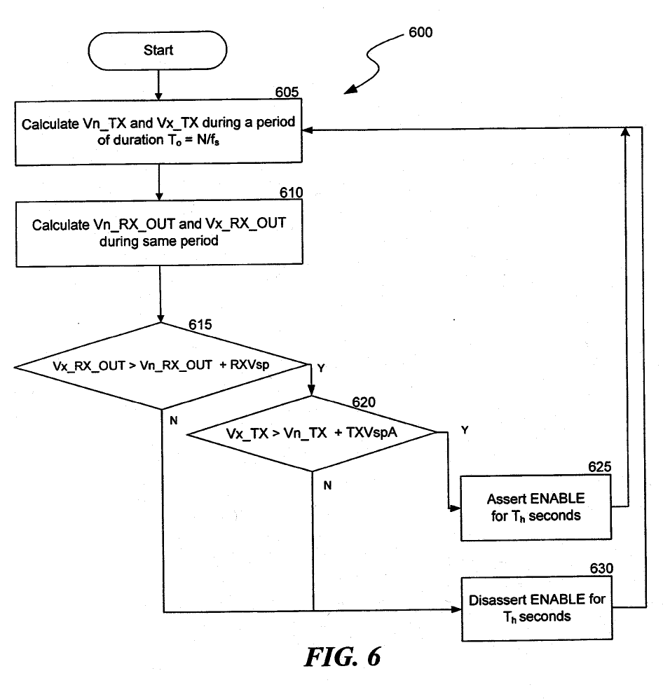

FIG. 6 is a flowchart of a process 600. As shown, process 600 illustrates specific calculations and state machine transitions that may be performed by digital logic module 526 to set control signal ENABLE. To implement the steps of process 600, digital logic module 526 may utilize programmable and/or calculated variables. Programmable variables may be set by a microprocessor and may be stored in volatile or non-volatile memory. Programmable variables may also be either user modifiable or fixed.

For clarity, process 600 is described as performed by particular elements of the double-talk detector 520 of FIG. 5. However, process 600 may also be performed by other elements, or in other systems, whether or not such elements or systems are described herein.

Table 1 illustrates the programmable variables referred to in FIG. 6 and provides typical values for these programmable variables. Some embodiments may also include a serial peripheral interface (SPI) to enable a user or other circuit to set or otherwise adjust these variables.

TABLE 1
Programmable variables of digital logic module 526.

| Variable | Description | Typical Values |
|---|---|---|
| N | Total number of samples collected | 2000 |
| | during a period. | |
| Nx | Number of samples used to | 128 or 100 |
| | calculate signal power of a signal | |
| | during a period. | |
| Nn | Number of samples used to | 128 or 100 |
| | calculate background noise of a | |
| | signal during a period. | |
| RXVsp | Speech or sound detection | 12 dB |
| | threshold for signal RX_OUT. | |
| TXVspA | Speech or sound detection | Set equal to |
| | threshold for signal TX, when | RXVsp or 5 dB |
| | speech or sound is detected on | |
| | signal RX_OUT (i.e., under a | |
| | double-talk condition) | |
| Tₕ | Receive or transmit mode hold time. | 3 ms |

Table 2 describes the calculated variables referred to by FIG. 6, including the calculation made for each variable.

TABLE 2
Calculated variables of digital logic module 526.

| Variable | Description | Calculation |
|---|---|---|
| Vx_TX | Signal power level of signal TX. | Mean of the Nx samples of signal |
| | | TX_N with the highest power. |
| Vn_TX | Background noise level of signal | Mean of the Nn samples of signal |
| | TX. | TX_N with the lowest power. |
| Vx_RX_OUT | Signal power level of signal | Mean of the Nx samples of signal |
| | RX_OUT. | RX_OUT_N with the highest power. |
| Vn_RX_OUT | Background noise level of signal | Mean of the Nn samples of signal |
| | RX_OUT. | RX_OUT_N with the lowest power. |

At block 605, digital logic module 526 calculates variables Vn_TX and Vx_TX, during a period of duration Tₒ=N/fₛ, where fₛ is the sampling frequency of the double-talk detector 520. As shown above in Table 2, these calculated values may correspond to the background noise and signal power of signal TX, respectively. At block 610, digital logic module 526 calculates Vn_RX_OUT and Vx_RX_OUT during substantially the same period. As shown above in Table 2, these calculated values may correspond to the background noise and signal power of receiver output signal RX_OUT, respectively.

At block 615, digital logic module 526 determines if a non-noise signal is present on receiver output signal RX_OUT, by evaluating the logic statement Vx_RX_OUT >Vn_RX_OUT+RXVsp, where RXVsp is a speech or sound detection threshold of receiver output signal RX_OUT. If no speech or sound is detected on receiver output signal RX_OUT, at block 630 digital logic module 526 may deassert control signal ENABLE for Tₕ seconds.

If speech or sound is detected on receiver output signal RX_OUT, digital logic module 526 then determines, at decision block 620 whether speech or sound on transmit signal TX exceeds a double-talk threshold by evaluating the logic statement Vx_TX>Vn_TX+TXVspA, where TXVspA is a programmable double-talk threshold. If no speech or sound is detected on signal TX, at block 630 digital logic module 526 deasserts control signal ENABLE for Tₕ seconds.

In one embodiment, if speech or other sound is detected on both signals RX_OUT and TX, at block 625 digital logic module 526 asserts control signal ENABLE for Tₕ seconds.

Process 600 may be repeated indefinitely or for a finite period during the operation of the echo canceller 100.

Those skilled in the art will appreciate that the blocks shown in FIG. 6 may be altered in a variety of ways. For example, the order of blocks may be rearranged, sub-steps may be performed in parallel, shown blocks may be omitted, or other blocks may be included, etc. For example, two or more of the decisions made at blocks 615 and 620 may be implemented concurrently and/or may be implemented in part using one or more exclusive-OR (XOR) gates.

The components, blocks, circuits, and the like illustrated herein may represent functional blocks of executable code to be executed on a DSP or other processor. However, they may also be embodied as digital circuitry, analog circuitry, and/or digital/analog circuitry in a programmable logic device, a field programmable gate array, discrete components, an application-specific integrated circuit, and/or the like.

While the above description describes certain embodiments of the invention, and describes the best mode contemplated, no matter how detailed the above appears in text, the invention can be practiced in many ways. Details of the system may vary in implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

We claim:

1. An apparatus for echo cancellation, comprising:
an echo compensator configured to receive a receiver input signal having at least an echo component and a received signal component, to receive an enable signal, to receive a transmit signal, and to provide a receiver output signal based on filtering the receiver input signal; and
a double talk detector configured to receive the receiver output signal, to receive the transmit signal, and to provide the enable signal based on the receiver output signal and the transmit signal.

2. The apparatus of claim 1, wherein the echo compensator is configured to estimate the echo component of the receiver input signal and to provide the receiver output signal based on subtracting the estimated echo component from the receiver input signal.

3. The apparatus of claim 1, wherein the echo compensator and the double talk detector are implemented as digital signal processor (DSP) code to be executed on a DSP.

4. The apparatus of claim 1, wherein the echo controller is configured to truncate one or more least significant bits and to perform a fixed point operation on one or more most significant bits.

5. The apparatus of claim 1, wherein the echo compensator includes:
a compensation controller configured to receive the enable signal, to receive the receiver output signal, and to provide filter coefficients based on the receiver output signal and the enable signal;
a filter configured to receive the filter coefficients, to receive the transmit signal, and to provide an estimated echo signal based on the transmit signal as an estimate of the echo component of the receiver input signal; and
a subtractor configured to receive the estimated echo signal, to receive the receiver input signal, and to provide the receiver output signal based on subtracting the estimated echo signal from the receiver input signal.

6. The apparatus of claim 5, wherein the filter is a finite impulse response (FIR) filter.

7. The apparatus of claim 6, wherein the FIR filter has a gain that is approximately equal to 6 decibels.

8. The apparatus of claim 5, wherein the compensation controller is configured to selectively update the filter coefficients if the enable signal is at a first value and to hold the filter coefficients unchanged if the enable signal is at a second value.

9. The apparatus of claim 5, wherein the compensation controller is configured to provide the filter coefficients based on a normalized least mean squares (NLMS) algorithm.

10. The apparatus of claim 9, wherein the NLMS algorithm is characterized by the equation:
$${a}_{k} ( n + 1 ) = {a}_{k} ( n ) + \frac{μ e ( n )}{P ( n )} * y ( n ) ,$$
wherein n represents an iteration number, aₖ(n) represents the filter coefficients, μ represents an iteration step size, e(n) represents the receiver output signal, P(n) represents a power of the receiver input signal, and y(n) represents the receiver input signal.

11. The apparatus of claim 1, wherein the double talk detector includes:
a first comparator configured to receive a threshold signal, to receive the receiver output signal, and to provide a double talk comparison signal based on a comparison of the receiver output signal to the threshold signal;
a second comparator configured to receive the transmit signal, to receive the receiver output signal, and to provide a feedback threshold signal based on a comparison of the receiver output signal to the transmit signal; and
a logic module configured to receive the feedback comparison signal, to receive the double talk comparison signal, and to provide the enable signal based on the feedback comparison signal and the double talk comparison signal.

12. The apparatus of claim 11, wherein the logic module includes:
an AND gate configured to provide the enable signal as a logically AND of the feedback comparison signal and the double talk comparison signal.

13. The apparatus of claim 1, further comprising:
an analog to digital converter configured to receive an analog receiver input signal and to provide the receiver input signal; and
a digital to analog converter configured to receive the transmit signal and to provide an analog transmit signal.

14. A method of echo cancellation, comprising:
receiving a receiver input signal having at least an echo component and a received signal component;
receiving a transmit signal; and
providing a receiver output signal, including:
estimating the echo component from the transmit signal based on selectively updated filter coefficients;
selectively updating the filter coefficients based on an enable signal, wherein the enable signal is based on a comparison of the transmit signal to the receiver output signal; and
subtracting the estimated echo component from the receiver input signal.

15. The method of claim 14, wherein estimating the echo component includes:
employing a finite impulse response (FIR) filter to provide the estimated echo component from the transmit signal.

16. The method of claim 14, wherein selectively updating the filter coefficients includes:
updating the filter coefficients if the enable signal is at a first value; and
holding the filter coefficients unchanged if the enable signal is at a second value.

17. The method of claim 14, wherein selectively updating the filter coefficients is further based on a normalized least mean squares (NLMS) algorithm.

18. The method of claim 17, wherein the NLMS algorithm is characterized by the equation:
$${a}_{k} ( n + 1 ) = {a}_{k} ( n ) + \frac{μ e ( n )}{P ( n )} * y ( n ) ,$$
wherein n represents an iteration number, aₖ(n) represents the filter coefficients, μ represents an iteration step size, e(n) represents the receiver output signal, P(n) represents a power of the receiver input signal, and y(n) represents the receiver input signal.

19. An apparatus for echo cancellation, comprising:
first means for receiving a receiver input signal having at least an echo component and a received signal component;
second means for receiving a transmit signal; and
third means for providing a receiver output signal, including:
fourth means for estimating the echo component from the transmit signal based on selectively updated filter coefficients;
fifth means for selectively updating the filter coefficients based on an enable signal, wherein the enable signal is based on a comparison of the transmit signal to the receiver output signal; and
sixth means for subtracting the estimated echo component from the receiver input signal.

20. The apparatus of claim 19, wherein the filter coefficients are further based on a normalized least mean squares (NLMS) algorithm characterized by the equation:
$${a}_{k} ( n + 1 ) = {a}_{k} ( n ) + \frac{μ e ( n )}{P ( n )} * y ( n ) ,$$
wherein n represents an iteration number, aₖ(n) represents the filter coefficients, μ represents an iteration step size, e(n) represents the receiver output signal, P(n) represents a power of the receiver input signal, and y(n) represents the receiver input signal.
